(19) United States
(12) Patent Application Publication
(10) Pub. No.: US 2010/0033760 A1
(43) Pub. Date: Feb. 11, 2010

(54) INFORMATION PROCESSING APPARATUS, INFORMATION PROCESSING METHOD, AND COMPUTER-READABLE STORAGE MEDIUM

(75) Inventor: Yoshio Kimura, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/537,108

(22) Filed: Aug. 6, 2009

(30) Foreign Application Priority Data
Aug. 8, 2008 (JP) 2008-205616

(51) Int. Cl. G06F 15/00

(52) U.S. Cl. 358/1.15

(57) ABSTRACT

A information processing apparatus includes a transmission unit configured to transmit data to the outside based on a set transmission address, a reception-unit configured to receive address data for setting the transmission address from an information terminal via a communication medium, and a display unit configured to display, when the address data received by the reception unit contains a plurality of addresses, a selection screen for prompting a user to select an address to be set as the transmission address among the plurality of addresses according to reception of the address data, and a setting unit configured to set, when a number of addresses contained in the address data received by the reception unit is one, the address as the transmission address without displaying the selection screen.

### BACKGROUND OF THE INVENTION

1. Field of the Invention

The present invention relates to an information processing apparatus that includes a transmission unit, an information processing method for the information processing apparatus, and a computer-readable storage medium storing a computer-executable process.

2. Description of the Related Art

Development of multifunction peripherals (MFPs) including scanning, printing and copying functions has caused the emergence of a multifunction peripheral that includes a facsimile transmission/reception function and a transmission function for transmitting scanned data as an attachment of e-mail or transmitting the scanned data to a file server. A transmission destination to be entered when such transmission function is executed is generally input by operating an operation panel of the multifunction peripheral. For example, correctly inputting an e-mail address is frequently a burden on a user. It is because the operation panel of the multifunction peripheral generally includes no input unit such as a keyboard.

A multifunction peripheral has thus been developed which can be fed with address data registered in an address book of a portable telephone as a transmission destination by using a wireless communication function such as an IrDA communication or Bluetooth (as discussed in Japanese Patent Application Laid-Open No. 2004-40206).

Concerning address data stored in an information terminal such as a portable telephone, a plurality of telephone numbers and a plurality of mail addresses may be registered in one destination. In such a case, in the above described conventional art, a plurality of telephone numbers and a plurality of mail addresses registered for a certain destination may be set all as transmission destinations. Consequently, even when a user wishes to set specific one of the plurality of telephone numbers or mail addresses as a transmission destination, data may be transmitted to a destination that the user does not intend. In other words, after setting the transmission destinations, the user has to cancel unnecessary transmission destinations, which is a burdensome operation. Even when the multifunction peripheral includes no facsimile function, a telephone number may be set as a transmission destination. Consequently, when the user instructs to make a transmission without knowing it, a transmission error may occur. In other words, the multifunction peripheral has operational inconvenience because destination information which actually cannot be used may be set as a transmission destination.

### SUMMARY OF THE INVENTION

An embodiment of the present invention is directed to improvement of operability when an information processing apparatus such as a multifunction peripheral uses address data registered in an information terminal such as a portable telephone.

According to an aspect of the present invention, an information processing apparatus includes a transmission unit configured to transmit data to the outside based on a set transmission address, a reception unit configured to receive address data for setting the transmission address from an information terminal via a communication medium, and a display unit configured to display, when the address data received by the reception unit contains a plurality of addresses, a selection screen for prompting a user to select an address to be set as the transmission address among the plurality of addresses according to reception of the address data, and a setting unit configured to set, when a number of addresses contained in the address data received by the reception unit is one, the address as the transmission address without displaying the selection screen.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a general multifunction peripheral.

FIG. 2 is a block diagram illustrating a schematic configuration of a general portable telephone.

FIG. 3 illustrates a configuration of an image information system according to an exemplary embodiment of the present invention.

FIG. 4 illustrates an example of a screen displayed on a display by a multifunction peripheral that is an exemplary embodiment of the present invention: the screen for prompting a user to log into the multifunction peripheral.

FIG. 5 illustrates an example of a screen displayed on the display by the multifunction peripheral of the exemplary embodiment of the present invention: the screen for setting restrictions on new destinations.

FIG. 6 illustrates an example of a screen displayed on the display by the multifunction peripheral of the exemplary embodiment of the present invention: the screen for setting restrictions on facsimile transmission.

FIG. 7 illustrates an example of a screen displayed on the display by the multifunction peripheral of the exemplary embodiment of the present invention: the screen for setting restrictions on electronic mail transmission domains.

FIG. 8 illustrates an example of address data received by the multifunction peripheral in the image information system of the exemplary embodiment of the present invention.

FIG. 9 illustrates an example of address data received by the multifunction peripheral in the image information system of the exemplary embodiment of the present invention.

FIG. 10 illustrates an example of address data received by the multifunction peripheral in the image information system of the exemplary embodiment of the present invention.

FIG. 11 is a flowchart illustrating an example of a creating procedure of a filtering list used by the multifunction peripheral of the exemplary embodiment of the present invention.

FIG. 12 is a flowchart illustrating an example of a filtering procedure executed by the multifunction peripheral of the exemplary embodiment of the present invention.

FIG. 13 illustrates an example of a screen displayed on the display by the multifunction peripheral of the exemplary embodiment of the present invention: the transmission screen where no address of a transmission destination has been set.

FIG. 14 illustrates an example of a screen displayed on the display by the multifunction peripheral of the exemplary embodiment of the present invention: the screen for prompting the user to perform infrared data communication:

FIG. 15 illustrates an example of a screen displayed on the display by the multifunction peripheral of the exemplary embodiment of the present invention: the screen for presenting a plurality of selectable addresses to prompt a user to select a target address.

FIG. 16 illustrates an example of a screen displayed on the display by the multifunction peripheral of the exemplary embodiment of the present invention: the transmission screen where one address of a transmission destination has been set.

FIG. 17 is a flowchart illustrating an example of a filtering procedure executed by the multifunction peripheral of the exemplary embodiment of the present invention.

### DETAILED DESCRIPTION OF THE EMBODIMENTS

Various exemplary embodiments, features, and aspects of the invention will be described in detail below with reference to the drawings.

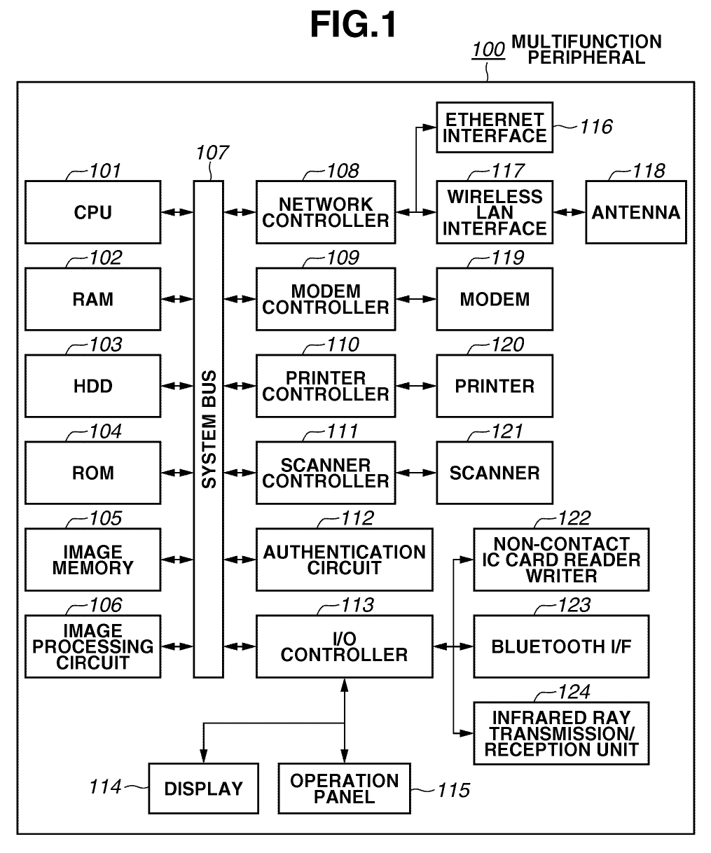

A multifunction peripheral that is an exemplary embodiment of the present invention will be described. The multifunction peripheral has an internal configuration as illustrated in FIG. 1. The internal configuration of a multifunction peripheral 100 will be described below in detail. The present invention can be applied to an information processing apparatus that receives address data from the outside and sets the address data as a data transmission destination.

The multifunction peripheral 100 includes a central processing unit (CPU) 101, a read-only memory (ROM) 104, and a random access memory (RAM) 102. The CPU 101 operates according to a program stored in the ROM 104 or a hard disk drive (HDD) 103. The RAM 102 is used as a program execution area. The CPU 101 controls each unit connected to a system bus 107.

The multifunction peripheral 100 includes a display unit and an input operation unit as user interfaces (I/F). The display unit is a display 114, and the input operation unit is an operation panel 115. The display 114 may have a touch panel function to serve as an input operation unit as well. The display 114 displays a driving condition of the multifunction peripheral, an apparatus status or various pieces of information such as input information. The multifunction peripheral 100 receives an input from the operation panel 115 to switch various functions included therein.

The multifunction peripheral 100 includes a network controller 108 as a communication control unit. The network controller 108 is connected to an Ethernet (registered trademark) interface 116 and a wireless local area network (LAN) interface 117 to control communication. A modem controller 109 is connected to a public switched telephone network (PSTN) via a modem 119 to control communication. The modem 119 modulates an input from the modem controller 109 and transmits the modulated input to the PSTN. Similarly, the modem 119 demodulates an input from the PSTN and transmits the demodulated input to the modem controller 109. The modem 119 controls connection and disconnection of a line. The CPU 101 can issue a control command to the network controller 108 and the modem controller 109 according to the program. Thus, for example, the multifunction peripheral 100 can perform transmission and reception of image data, text data and a control command via a network, and facsimile transmission and reception via the PSTN.

The multifunction peripheral 100 includes, as a communication medium for connecting with an external device, for example, a non-contact integrated circuit (IC) card reader/writer compatible to near field communication (NFC) that has become an international standard as short-range wireless communication standard ISO/IEC IS 18092. Further, the multifunction peripheral 100 includes Bluetooth (registered trademark) I/F and an infra red ray transmission/reception-unit. In addition, the multifunction peripheral 100 can be connected to the external device via, for example, wireless communication represented by Wi-Fi (registered trademark), wire communication represented by Ethernet (registered trademark) or a modem. The multifunction peripheral 100 can transmits and receives commands and data to and from various peripheral devices via the non-contact IC card reader writer 122, the Bluetooth I/F 123, and the infrared ray transmission/reception unit 124.

An in and out (I/O) controller 113 is connected to the non-contact IC card reader writer 122, the Bluetooth I/F 123, and the infrared ray transmission/reception unit 124 to relay inputs from various I/Fs. The non-contact IC card reader writer 122 and the Bluetooth I/F 123 incorporate antennas.

A scanner 121 can read images. Accordingly, the multifunction peripheral 100 can store data read by the scanner 121 in a storage medium such as the HDD 103. Further, the multifunction peripheral 100 can transmit the data read by the scanner 121 by e-mail or facsimile. Alternatively, the multifunction peripheral 100 can transmit the data based on a file transfer protocol (FTP), a service message block (SMB) or IFAX. The multifunction peripheral 100 can print the data read by the scanner 121 by a printer 120.

An image processing circuit 106 is an exclusive circuit for executing image conversion in the multifunction peripheral 100. For example, the image processing circuit 106 performs encoding of image data transmitted by the multifunction peripheral 100 or magnification conversion by compressing or decompressing received image data. The image processing circuit 106 performs other image conversions such as conversion of a plurality of pieces of image data into a one-page image, conversion of printed data into image data, and format-conversion to store image data in the HDD. The image processing circuit 106 may perform image correction processing according to optical response characteristics of the scanner 121 or a variance of a sensor, or image optimization processing according to writing characteristics of the printer 120.

The multifunction peripheral 100 includes an image memory 105 for temporarily storing image data or printed data for image processing. The multifunction peripheral 100 may use the HDD 103 or the RAM 102 in place of the image memory according to a status of the device.

An authentication unit 112 is an exclusive circuit for performing print job authentication processing in addition to authentication processing of a user or a work group. The authentication unit 112 may store authentication information therein or in the external HDD 103.

The system bus 107 interconnects control units such as the CPU 101, the RAM 102, the HDD 103 and the ROM 104. Further, the system bus 107 is connected to various controllers such as a printer controller 110, a scanner controller 111, the network controller 108, the modem controller 109, and the I/O controller 113. The system bus 107 is connected to such exclusive processing circuits as the image memory 105, the image processing circuit 106, and the authentication circuit 112.

The multifunction peripheral 100 thus configured can be used as not only a copying machine but also a facsimile apparatus, a printer apparatus or a scanner apparatus.

For a printing method of the printer unit, any one of an electrophotography recording method, an ink-jet recording method, a thermal head method, and a dot-impact method can be used. Any I/O method of a scanner or the like, and any external interface method such as Ethernet (registered trademark) or an infrared ray transmission/reception unit can be used.

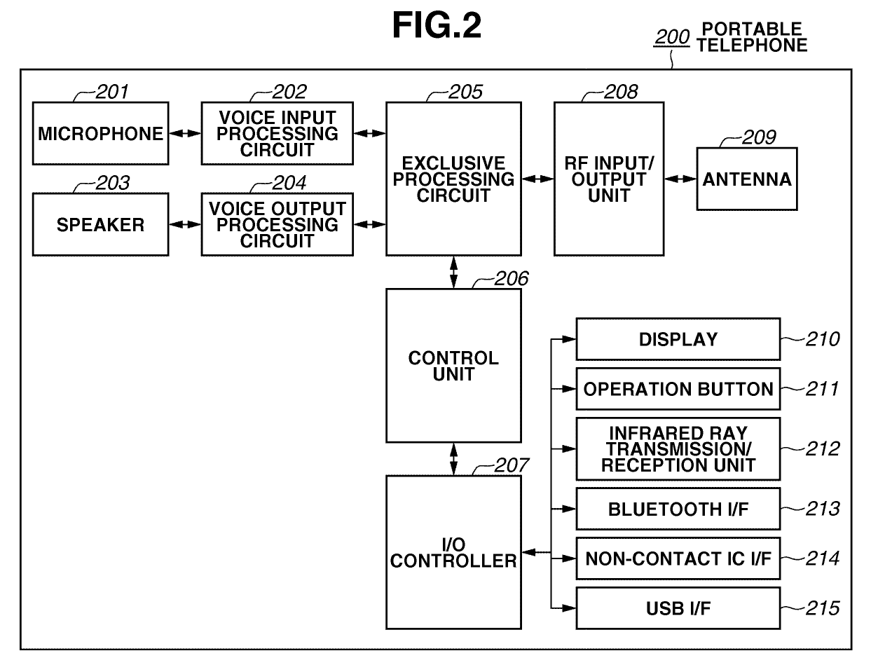

Next, as an example of an information terminal, an internal configuration of a portable telephone will be described. For example, the portable telephone has an internal configuration schematically illustrated in FIG. 2. The internal configuration of a portable telephone 200 will be described below. In the exemplary embodiment, a configuration of the portable telephone is described as an example. However, the present invention is applicable to an information terminal that has a communication function. For example, the present invention can be applied to an information processing apparatus such as a personal digital assistant (PDA) that includes an address book and a communication function. A transmission method of the address data may be implemented via an external network in addition to direct connection with the multifunction peripheral.

The portable telephone 200 includes a control unit 206, a display 210, an operation panel 211, an infrared ray transmission/reception unit 212, a non-contact IC card I/F 214, and a Bluetooth I/F 213.

The control unit 206 mainly implements functions of the portable telephone. The control unit 206 includes a CPU, a ROM and a RAM. The portable telephone 206 realizes a desired function in a manner that the CPU in the control unit 206 issues a command to each unit according to a program stored in the ROM in the control unit 206. The RAM in the control unit 206 stores addresses stored in the portable telephone.

An exclusive processing circuit 205 dedicated to digital signal processing is connected to a voice input processing circuit 202 to which a microphone 201 is connected and a voice output processing circuit 204 to which a speaker 203 is connected. The exclusive processing circuit 205 is connected to a radio frequency (RF) input/output unit 208 to which an antenna 209 is connected to encode or decode a digital voice signal.

The voice input processing circuit 202 converts an analog signal input from the microphone 201 into a digital signal. The voice output processing circuit 204 converts a digital signal input from the exclusive processing circuit 205 into a signal for driving the speaker.

The RF input/output unit 208 executes digital-to-analog (D/A) conversion for a signal input from the exclusive processing circuit 205, transmits radio waves via the antenna 209, and executes analog-to-digital (A/D) conversion for a signal received via the antenna 209 to output the converted signal to the exclusive processing circuit 205.

The display 210 displays and outputs information to the user. The operation panel 211 receives an input from the user. The portable telephone 200 includes, as external I/Fs, the infrared ray transmission/reception unit 212, the Bluetooth I/F 213, the non-contact IC I/F 214, and a universal serial bus (USB) I/F 215. The external I/Fs may be 16 pin connectors.

Thus, the portable telephone 200 can transmit address data stored therein to the outside by using a communication medium disposed in the portable telephone 200.

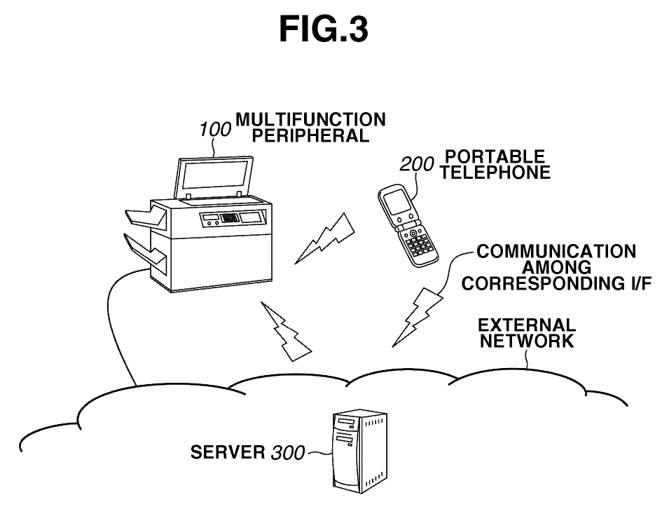

FIG. 3 illustrates an example of a system configuration to which the present invention is applied. In FIG. 3, the multifunction peripheral 100, the portable telephone 200, and the external network 300 can communicate with one another via corresponding communication media. The configuration of FIG. 3 is only an example of a general configuration. Thus, a portable terminal used by a general user may be another information device. The multifunction peripheral in the configuration illustrated in FIG. 3 is not limited to the multifunction peripheral of the above-described configuration, but may be a single device such as a scanner or a facsimile.

According to the present invention, the multifunction peripheral 100 performs processing for address data input from the outside. An example of the address data input to the multifunction peripheral from the outside is as follows.

The address data input from the outside includes one or more numbers, or one or more e-mail addresses, and one or more numbers and one or more e-mail addresses. The address data includes an attribute and an attribute value. The address data is set by, for example, the portable telephone. However, the attribute and the attribute value of the address data are not always in correct correspondence. For example, when an attribute is set to the portable telephone while a facsimile number is registered as an attribute number, there is no correct correspondence between the attribute and the attribute value. Further, the address data input to the multifunction peripheral may have various formats which has no attribute.

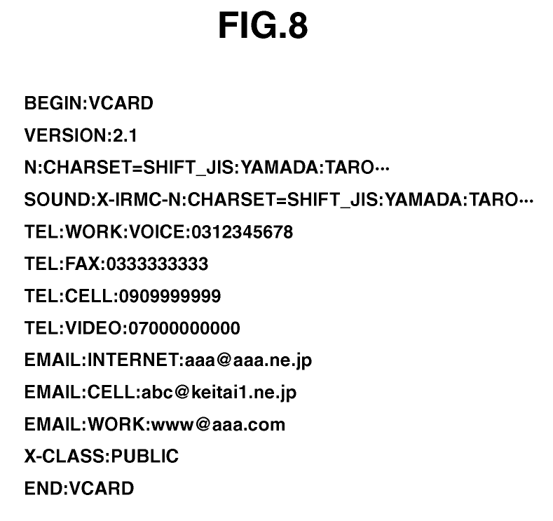

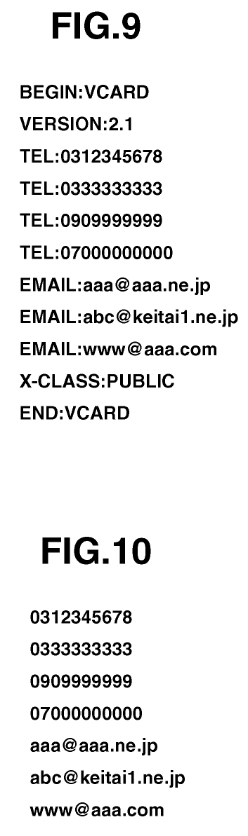

FIG. 8 illustrates an example of address data received by the multifunction peripheral. The address data has attributes such as “FAX” and “CELL” as a specific attribute. Further, the address data has attributes such as “TEL” and “EMAIL”, and corresponding attribute values. FIG. 9 illustrates another example of address data received by the multifunction peripheral. The address data has attributes such as “TEL” and “EMAIL”, and corresponding attribute values. FIG. 10 illustrates another example of address data received by the multifunction peripheral. The address data includes values that constitute the address data.

The above-described pieces of the address data are only examples, and formats of address data to be received are not limited thereto. For example, another format such as an extensible markup language (XML) may be used for the address data.

The multifunction peripheral 100 receives the address data shown in one of FIGS. 8 to 10 from its own communication medium. The multifunction peripheral 100 deploys the received address data in its RAM 102 to analyze the data by the CPU 101. The multifunction peripheral 100 can accordingly use types of various attribute values and attributes analyzed from the received address data.

In the system configuration illustrated in FIG. 3, the address data input from the portable telephone 200 that is an example of a portable information terminal is set as a transmission address of the multifunction peripheral 100. The transmission address is information for specifying a transmission destination when the multifunction peripheral 100 transmits data to the outside. Data to be transmitted may be, for example, image data read by the scanner 121 of the multifunction peripheral 100. The multifunction peripheral 100 determines a transmission address from the address data input from the outside by using setting information set thereto. An example of setting information that the user can set to the multifunction peripheral 100 will be described below. The setting information is stored in the RAM 102, for example.

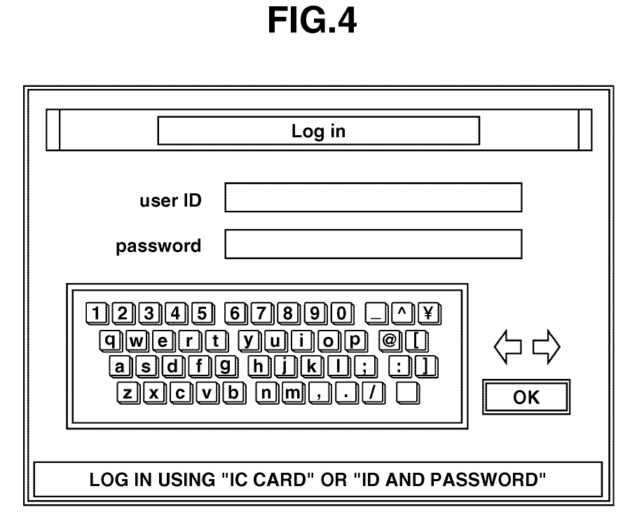

One piece of the setting information allowed to be set to the multifunction peripheral 100 is user information for identifying a user. The multifunction peripheral 100 displays a screen an example of which is illustrated in FIG. 4 on the display 114. The multifunction peripheral 100 can accordingly receive user information input from the operation panel 115. The multifunction peripheral 100 stores the received user information in the RAM 102. The user information may be input via an interface such as a non-contact IC card reader writer 122.

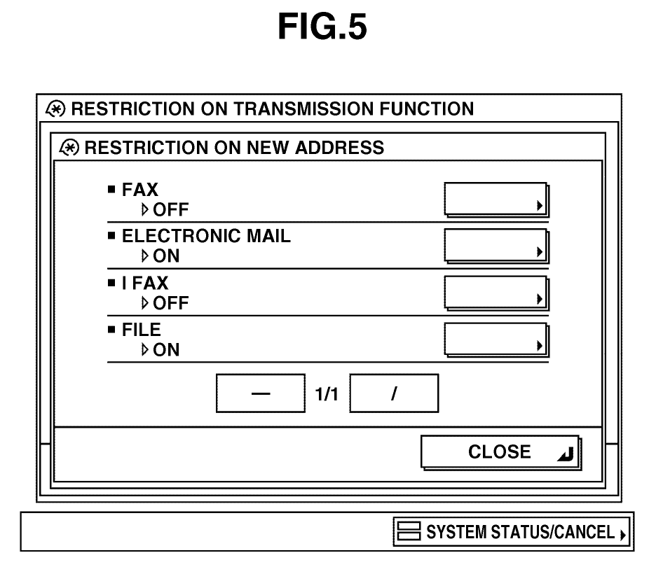

Similarly, one piece of the setting information allowed to be set in the multifunction peripheral 100 is restriction information describing restrictions on transmission functions. FIG. 5 illustrates an example of a screen displayed on the display 114 to enable the user to set restrictions on transmission functions. In the example of FIG. 5, the user can set which of a plurality of transmission functions of the multifunction peripheral 100 are made valid and invalid. In the example of FIG. 5, an electronic mail transmission function and a file transmission function are set valid, while a facsimile transmission function and an IFAX transmission function are set invalid. The restriction information includes, in addition to restrictions on the transmission functions, restrictions on numbers to be specified as destinations, and restrictions on domains.

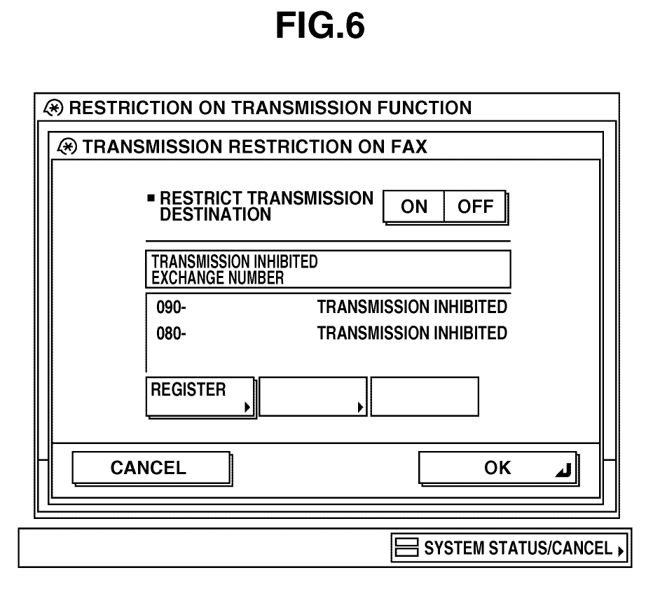

Restrictions using a number will be described below. The multifunction peripheral 100 displays a screen an example of which is illustrated in FIG. 6 on the display 114. The multifunction peripheral 100 accordingly changes a number which is restricted to be used as a designation according to an input from the operation panel 115. When restrictions are imposed on the destinations by the numbers as illustrated in FIG. 6, the restricted numbers cannot be used as transmission addresses. Thus, when the user manually inputs a restricted number by using the operation panel 115, the multifunction peripheral 100 restricts transmission to the input number as a transmission address. When address data input to the multifunction peripheral 100 from the infrared ray transmission/reception unit 124 contains a restricted number, the multifunction peripheral 100 restricts transmission to the restricted number. A destination may be restricted by a part of a number as illustrated in FIG. 6, or a designated number. For example, in the screen of FIG. 6, facsimile transmission to telephone numbers starting from “090” and “080” is restricted.

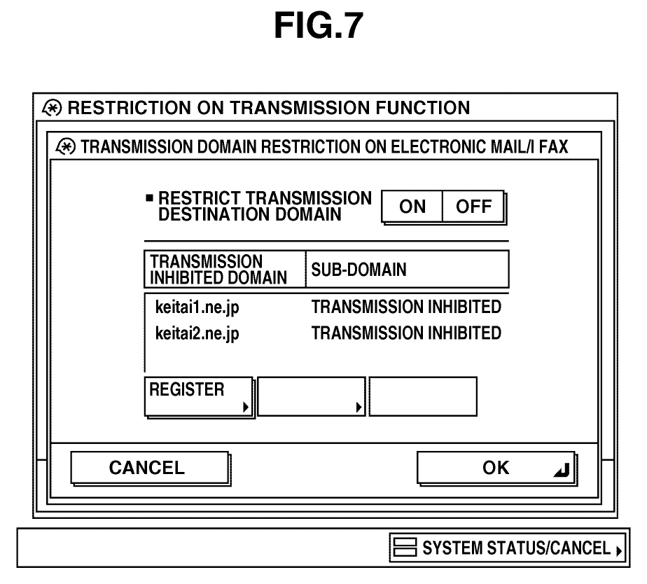

Restrictions using a domain will be described below. The multifunction peripheral 100 displays a screen an example of which is illustrated in FIG. 7. The multifunction peripheral 100 accordingly changes a domain described in the restriction information for restricting use as a destination according to an input from the operation panel 115. When destinations are restricted by the domains as illustrated in FIG. 7, the restricted domains cannot be used as the transmission addresses. Thus, when an e-mail address belonging to the restricted domain is manually input by using the operation panel 115, the multifunction peripheral 100 restricts transmission to the input e-mail address as a transmission address. When address data input to the multifunction peripheral 100 from the infrared ray transmission/reception unit 124 contains an e-mail address belonging to a restricted domain, the multifunction peripheral 100 restricts transmission to the restricted e-mail address. A destination may be restricted by a domain as illustrated in FIG. 7, or a designated e-mail address. For example, in the screen of FIG. 7, transmissions to e-mail addresses belonging to keitain1.ne.jp and keitai2.ne.jp are restricted.

The restriction information for restricting destinations can be changed via another interface in addition to the operation panel 115. For example, the user can change the restriction information via the Ethernet (registered trademark) interface 116. Further, the multifunction peripheral 100 receives an input of a change of the restriction information from the outside via the non-contact IC card reader writer 122, the Bluetooth I/f 123 or the infrared ray transmission/reception unit 124. The restriction information can be set according to the user information. In other words, different restriction information can be applied for each user who logs into the multifunction peripheral 100.

Next, a filtering list created based on the setting information in the multifunction peripheral 100 will be described. The filtering list describes conditions of addresses to be eliminated from input address data when a transmission address is set. The multifunction peripheral 100 creates a filtering list based on the setting information set in the RAM 102. The multifunction peripheral 100 stores the filtering list, for example, in the RAM 102. The CPU 101 obtains a change of the setting information to change the filtering list.

An operation of the CPU 101 when a filtering list is created will be described below.

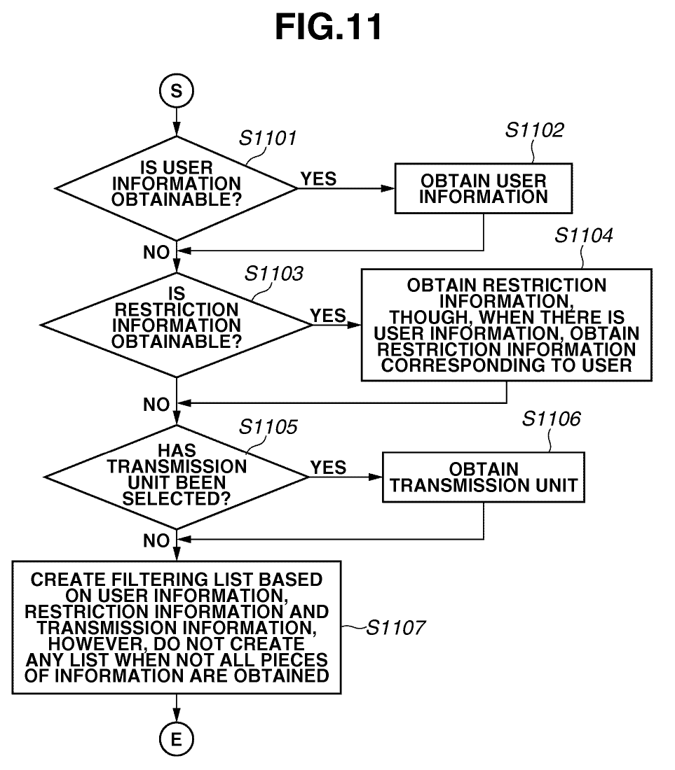

FIG. 11 is a flowchart illustrating processing of creating a filtering list by the CPU 101 of the multifunction peripheral 100. Each step will be described in detail below.

In step S1101, the CPU 101 determines whether user information has been stored in the RAM 102. If it is determined that the user information has been stored in the RAM 102 (YES in step S1101), then in step S1102, the CPU 101 obtains the user information stored in the RAM 102.

In step S1103, the CPU 101 determines whether restriction information has been stored in the RAM 102. If it is determined that the restriction information has been stored in the RAM 102 (YES in step S1103), the process proceeds to step S1104. In step S1104, the CPU 101 obtains the restriction information stored in the RAM 102. If the restriction information corresponding to a user has been stored, the CPU 101 obtains the restriction information corresponding to the user from the RAM 102.

In step S1105, the CPU 101 determines whether the user has selected a transmission unit. In other words, the CPU 101 determines which of facsimile transmission, electronic mail transmission and IFAX transmission is executed. The user selects the transmission unit by selecting a button of “FAX”, “FILE” or “ELECTRONIC MAIL”. If it is determined that the transmission unit has been selected (YES in step S1105), then in step S1106, the CPU 101 obtains information indicating the selected transmission unit.

The filtering list includes the conditions or information about the addresses eliminated from the transmission addresses. In step S1107, the CPU 101 adds conditions of destinations restricted by the restriction information and designated addresses to the filtering list. Further, the CPU 101 creates the filtering list by using the restriction information corresponding to the user specified by the user information. If the transmission unit has been selected, the CPU 101 adds destinations other than a destination which can be set by the selected transmission unit as elimination conditions to the filtering list. The filtering list thus created is stored in the RAM 102.

For example, the CPU 101 obtains the user information, the transmission unit and the restriction information as the setting information. When a facsimile is selected as the transmission unit, the CPU 101 adds conditions of eliminating e-mail addresses to the filtering list. When the user information is obtained and there is corresponding restriction information, the CPU 101 adds conditions of eliminating addresses designated by the restriction information to the filtering list. For example, when a user “A” is not allowed to perform transmission to a specific address “aaa@aaa.com” and facsimile-transmission to a facsimile number having “090” at its head, the CPU 101 adds these conditions to the filtering list.

Using the created filtering list, the CPU 101 of the multifunction peripheral 100 performs filtering for an address list input from an infrared port. When the user directly sets a transmission address by the operation panel 115, the CPU 101 inhibits transmission to the address described in the filtering list. The filtering list may be edited via the operation panel 115. The filtering list may be changed from the outside. For example, transmitting the filtering list to a plurality of multifunction peripherals via Ethernet enables the plurality of multifunction peripherals to set values in the same filtering list. For managing the plurality of multifunction peripherals, the multifunction peripheral 100 may receive the filtering list itself, or the restriction information. A filtering list can be created anytime before execution of filtering. The CPU 101 may perform filtering by-using the-user information, the setting information and the transmission unit without creating any filtering list. A method for performing filtering without using any filtering list will be described below.

An operation of the multifunction peripheral 100 when address data input from an external apparatus such as the portable telephone 200 is set in a transmission address will be described.

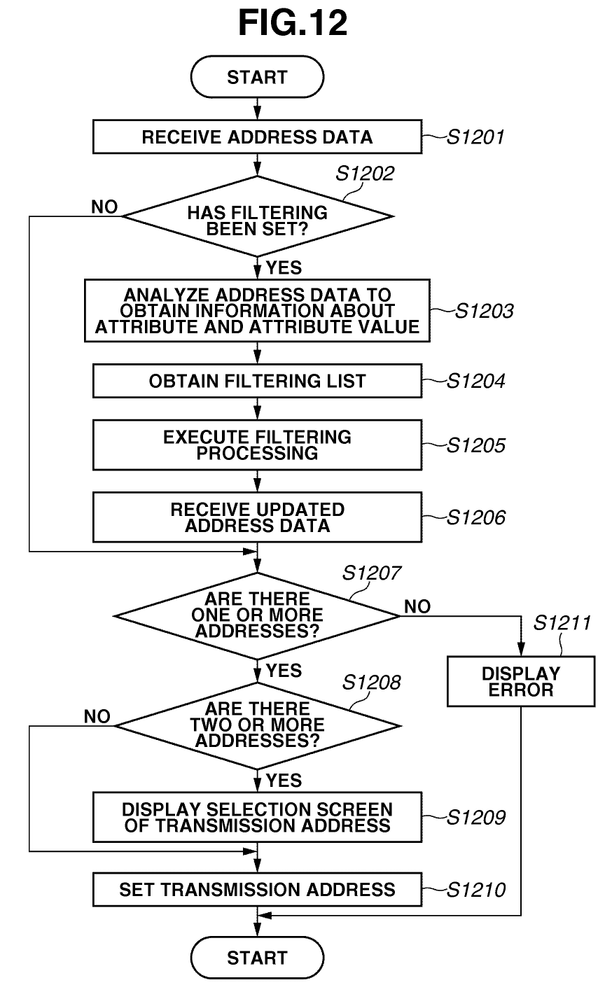

FIG. 12 is a flowchart illustrating processing executed by the multifunction peripheral 100. The CPU 101 controls the multifunction peripheral 100 according to a program describing processing of the flowchart of FIG. 12 stored in a memory such as the ROM 104. The multifunction peripheral 100 can transmit data stored in the HDD 103 or image data read by the scanner 121 to the outside by a transmission unit such as a facsimile or mail. When transmitting data to the outside, the multifunction peripheral 100 needs a telephone number or an e-mail address as a data transmission address.

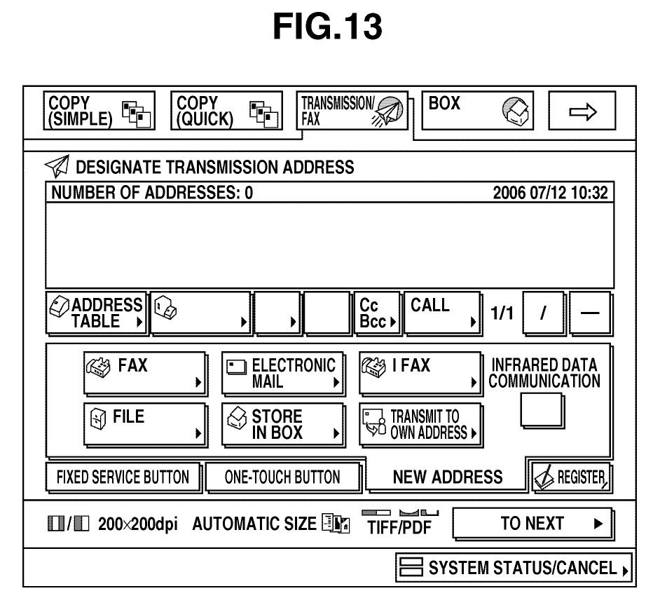

The CPU 101 displays a screen for prompting the user to input a data transmission address on the display 114. FIG. 13 displays an example of a screen displayed on the display 114 of the multifunction peripheral 100 to prompt the user to input a transmission address as a data transmission destination. When the CPU 101 detects selection of an “INFRARED DATA COMMUNICATION” button illustrated in FIG. 13, the CPU 101 obtains address data input from an information terminal such as the portable telephone 200 via the infrared ray transmission/reception unit 124. In the exemplary embodiment, obtaining address data via the infrared ray transmission/reception unit 124 is described as an example. However, the CPU 101 may obtain address data by another interface installed in the multifunction peripheral 100.

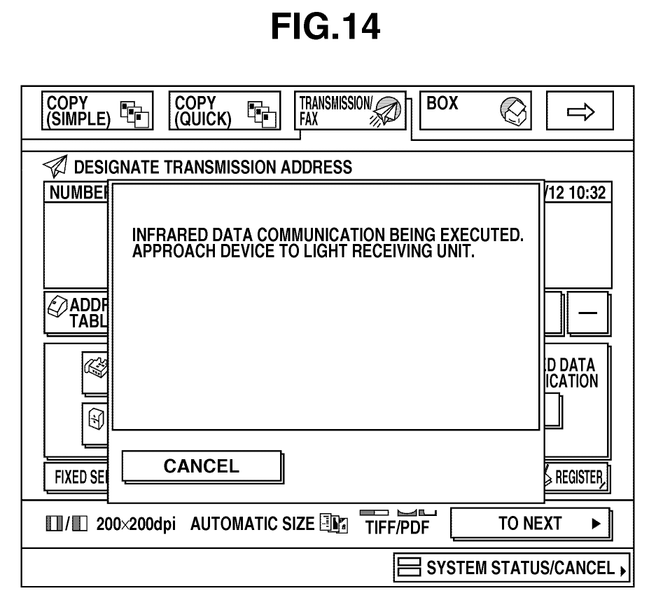

After the user has selected the “INFRARED DATA COMMUNICATION”, the CPU 101 controls the infrared ray transmission/reception unit 124 to wait for address data input from the outside. Simultaneously, the CPU 101 displays a screen illustrated in FIG. 14 for prompting the user to transmit the address data.

In step S1201, when the address data is transmitted from an information terminal such as the portable telephone 200, the CPU 101 obtains the address data input from the infrared ray transmission/reception unit 124.

If no address data is input within predetermined time, the CPU 101 cancels reception of the address data as timeout processing. The CPU 101 can cancel reception of the address data by detecting selection of a “CANCEL” button displayed on the display 114 of FIG. 14.

After reception of the address data in step S1201, in step S1202, the CPU 101 determines whether filtering has been set. More specifically, the CPU 101 determines whether a filtering list has been created by the processing described above referring to FIG. 11.

If it is determined that filtering has been set (YES in step S1202), the process proceeds to step S1203. On the other hand, if it is determined that filtering has not been set (NO in step S1202), the process proceeds to step S1207.

In step S1203, the CPU 101 analyzes the received address data to obtain information about an attribute and an attribute value of the address data. When the address data shown in FIG. 8 is received, the CPU 101 obtains “TEL”, “EMAIL”, “FAX”, and “CELL” as the attribute information. The CPU 101 obtains “0333333333”, “09099999999”, “07000000000” and “aaa@aaa.ne.jp” as the attribute values.

In step S1204, the CPU 101 obtains the filtering list created in the processing of FIG. 11 and stored in the RAM 102.

In step S1205, the CPU 101 executes filtering based on the information about the attribute and the attribute value obtained in step S1203 and the filtering list obtained in step S1204. More specifically, the CPU 101 eliminates an address that includes an attribute or an attribute value matching the conditions described in the filtering list from the obtained address data and updates the address data.

For example, it is presumed that restrictions have been set on the transmission functions as illustrated in Figs. 5 to 7 and the filtering list has been created. In other words, the facsimile function and the IFAX function are OFF, and facsimile transmission to the telephone numbers starting from “090” and “080” is inhibited. IFAX and electronic mail transmission to addresses of the domains of “keitai1.ne.jp” and “keitai2.ne.jp” is inhibited.

When a filtering list which includes above described conditions has been set, the following filtering is performed after reception of the address data shown in FIG. 8. First, because the facsimile function is OFF, addresses which have the attribute “TEL” are eliminated from the address data. Since IFAX and electronic mail transmission to the address of the domain of “keitai1.ne.jp” is inhibited, address which has the attribute value of “abc@keitai1.ne.jp” is eliminated from the address data. As a result, the CPU 101 updates the obtained address data to address data which contains only addresses having the attribute values of “aaa@aaa.ne.jp” and “www@aaa.com”. The CPU 101 stores the updated address data in the RAM 102.

In step S1206, after the above described filtering, the CPU 101 obtains the updated address data from the RAM 102. In step S1207, the CPU 101 determines whether a number of addresses contained in the obtained address data is one or more. At this point, if filtering has been set, the address data is the address data updated in step S1206. If no filtering has been set, the address data is the address data obtained in step S1201. If no address is contained in the address data (No in step S1207), then in step S1211, the CPU 101 displays an error screen indicating that there is no address which can be set as a transmission address on the display 114.

On the other hand, if it is determined that the number of addresses contained in the address data is one or more (YES in step S1207), the process proceeds to step S1208. In step S1208, the CPU 101 determines whether the address data contains two or more addresses.

If it is determined that there are two or more addresses (YES in step S1208), then in step S1209, the CPU 101 displays a list of a plurality of addresses contained in the address data as transmission address candidates on the display 114. In other words, the CPU 101 displays a selection screen for prompting the user to select addresses to be set as the transmission addresses among the plurality of addresses contained in the address data.

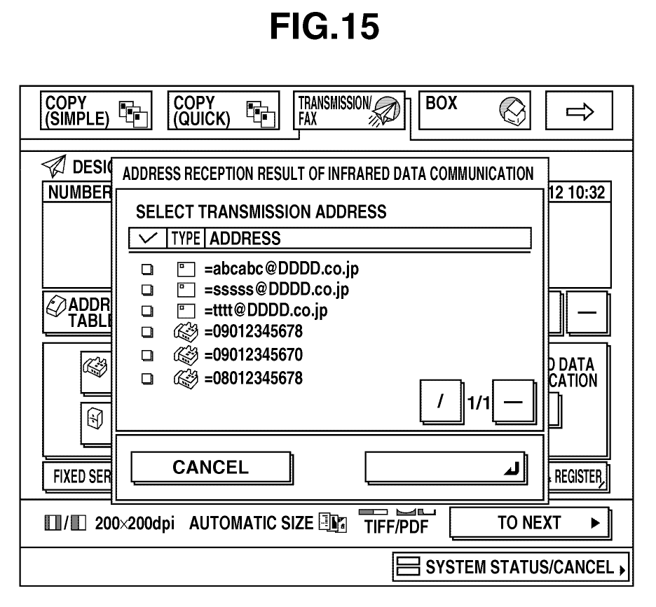

FIG. 15 illustrates an example of a selection screen displayed in step S1209. In the example of FIG. 15, total of six addresses including three mail addresses and three telephone numbers are displayed as the transmission address candidates. The user can select one or a plurality of desired addresses on the selection screen. The CPU 101 receives the addresses selected by the user from the selection screen illustrated in FIG. 15. In step S1210, the CPU 101 sets the selected addresses as data transmission addresses in the multifunction peripheral 100.

If it is determined that the address data does not contain two or more addresses (No in step S1208), in other words, the address data contains only one address, in step S1210, the CPU 101 sets the address as the transmission address. In this case, display of the selection screen of transmission addresses illustrated in FIG. 15 is skipped. However, in place of the selection screen, the CPU 101 may display a screen for prompting the user to check whether the address is permitted to be set as the transmission address.

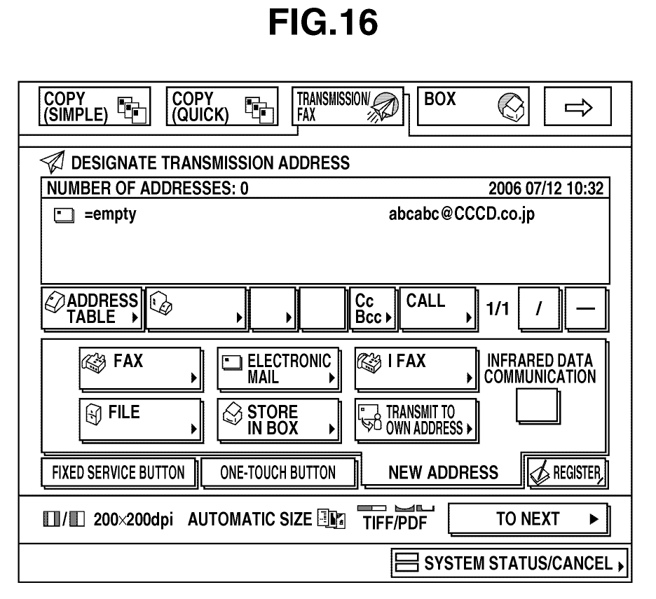

When the transmission address is set based on the address data input from the information terminal in step S1210, the CPU 101 displays a screen of FIG. 16 on the display 114 of the multifunction peripheral 100. In the screen of FIG. 16, the transmission address set in step S1210 is displayed in a destination section.

The user can select the transmission unit for transmitting data to the set transmission address from the screen. More specifically, by pressing a “FAX” or “ELECTRONIC MAIL” button, the user selects the transmission unit. If the user has already selected the transmission unit during creation of the filtering list by the processing shown in FIG. 11, the user doesn't have to select the transmission unit again because the selection is reflected in the screen.

If the user has not selected any transmission unit, and if the transmission unit can be specified by a type of the transmission address set in step S1210, the transmission unit may be automatically selected. For example, if the set transmission address is a telephone number, only facsimile transmission corresponds to telephone numbers. Thus, the CPU 101 can automatically select the transmission unit without causing the user to select any transmission unit.

If the transmission units cannot be specified to one by the type of the set transmission address, the CPU 101 may perform control to prevent the user from selecting the transmission unit which is inhibited data transmission by the set transmission address. For example, if the set transmission address is an e-mail address, the e-mail address cannot be used as the transmission address of facsimile transmission. Thus, a select button of “FAX” may be grayed out to inhibit the user from selecting it. This way, user operability can be improved.

When the processing of the flow illustrated in FIG. 12 is completed and the transmission address is determined, the user can operate the operation panel 115 to scan a document, and transmit image data to the set transmission address. The user can transmit data stored in the HDD 103. A sequence of inputting of data as a transmission target, determination of a transmission address, and selection of a transmission unit is not limited to the above.

As described above, when the obtained address data contains a plurality of addresses, the user selects an address to be set as a transmission address. Thus, transmission of data to destinations unintended by the user can be prevented. Further, it is not necessary to again change setting of the transmission address that has been set.

By performing filtering according to setting of the multifunction peripheral or the user information, address data to be set as the transmission address is filtered from the address data input from the information terminal. Thus, it can be prevented that data is mistakenly transmitted by a method or to a destination which cannot be used or are not allowed to use.

As described above, the user operability can be improved when the multifunction peripheral sets the transmission address based on the address data input from the information terminal.

Combining two or more filtering methods enables finer filtering. A filtering method may be changed by a user's instruction. Accordingly, the user can obtain a desired filtering strength, and reduction in usability caused by excessive filtering can be prevented.

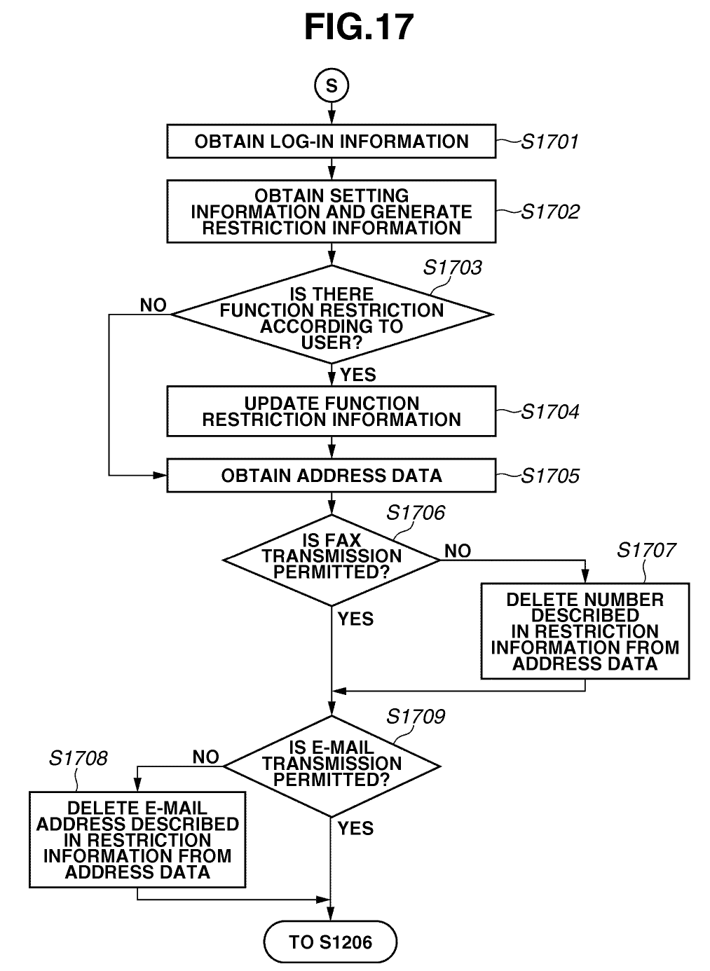

Next, filtering executed by the CPU 101 of the multifunction peripheral 100 when the multifunction peripheral 100 does not create the filtering list described above in the flow of FIG. 11 will be described. FIG. 17 is a flowchart illustrating processing of the multifunction peripheral 100 when filtering is performed without creating any filtering list.

In step S1701, the CPU 101 obtains log-in information when a user logs into the multifunction peripheral 100. The user performs logging-in by inputting user identification (ID) and a password to the multifunction peripheral 100 on the screen illustrated in FIG. 14.

In step S1702, the CPU 101 obtains setting information from the multifunction peripheral 100 to generate restriction information. The setting information is information indicating presence of a facsimile transmission function or ON/OFF of the function, or information indicating presence of an e-mail transmission function or ON/OFF of the function. However, another piece of information may be used. The restriction information is generated based on the setting information and is a collection of pieces of information indicating presence or ON/OFF of each function. The restriction information may include description of only valid functions, description of only invalid functions, or description of both valid and invalid functions.

In step S1703, the CPU 101 determines whether function restrictions according to the user have been set in the multifunction peripheral 100. For user information for specifying the user, the user ID input in step S1701 is used. The function restriction for each user is information such as “a user A is inhibited to use facsimile transmission function” or “a user B is inhibited to use e-mail transmission function”. If the function restriction has been set for each user (YES in step S1703), the process proceeds to step S1704. In step S1704, the CPU 101 updates the restriction information generated in step S1702 based on the function restriction for each user.

In step S1705, the CPU 101 obtains address data input from the information terminal. An inputting method is similar to that of step S1201 of FIG. 12, and thus description thereof will be omitted.

When the address data is obtained, then in step S1706, the CPU 101 refers to the restriction information generated in step S1702 or S1704 to determine whether facsimile transmission is permitted in the multifunction peripheral 100. If it is determined that facsimile transmission is not permitted (NO in step S1706), then in step S1707, the CPU 101 deletes a telephone number contained in the address data therefrom.

In step S1709, the CPU 101 refers to the restriction information generated in step S1702 or S1704 to determine whether E-mail transmission is permitted in the multifunction peripheral 100. If it is determined that e-mail transmission is not permitted (NO in step S1709), then in step S1708, the CPU 101 deletes a mail address contained in the obtained address data therefrom. Then the process proceeds to step S1206 of the flowchart of FIG. 12, and operates thereafter according to the flow of FIG. 12.

According to the present invention, a storage medium recording computer program codes of software for realizing the processing of the flowcharts of the exemplary embodiment may be supplied to or the apparatus. A computer (a central processing unit (CPU) or a micro processing unit (MPU)) of the system or the apparatus reads the program codes stored in the storage medium to execute them, so that the present invention can be implemented.

In this case, the program codes read from the storage medium themselves realize the functions of the exemplary embodiment, and the storage medium storing the program codes is included in the present invention.

For the storage medium to supply the program codes, for example, a floppy disk, a hard disk, an optical disk, a magneto-optical disk, a compact disc (CD)-ROM, a CD-readable (CD-R), a digital versatile disc (DVD)-ROM, a magnetic tape, a nonvolatile memory card, or a ROM can be used.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions. This application claims priority from Japanese Patent Application No. 2008-205616 filed Aug. 8, 2008, which is hereby incorporated by reference herein in its entirety.

What is claimed is:

1. An information processing apparatus that includes a transmission unit configured to transmit data to the outside based on a set transmission address, the information processing apparatus comprising:
a reception unit configured to receive address data for setting the transmission address from an information terminal via a communication medium;
a display unit configured to display, when the address data received by the reception unit contains a plurality of addresses, a selection screen for prompting a user to select an address to be set as the transmission address among the plurality of addresses according to reception of the address data; and
a setting unit configured to set, when a number of addresses contained in the address data received by the reception unit is one, the address as the transmission address without displaying the selection screen.

2. The information processing apparatus according to claim 1, further comprising a creation unit configured to create a filtering list which includes a condition for narrowing down addresses as candidates of the transmission address among the addresses contained in the address data received by the reception unit,
wherein the display unit displays an address filtered according to the filtering list created by the creation unit as the candidate of the transmission address.

3. The information processing apparatus according to claim 2, wherein the filtering list includes information indicating a function which cannot be executed by the information processing apparatus.

4. The information processing apparatus according to claim 2, wherein the filtering list includes information indicating a function, use of which may be restricted for each user.

5. The information processing apparatus according to claim 1, wherein the information terminal is a portable telephone, the address data is an address registered for one destination in the portable telephone, and the communication medium is infrared data communication, Bluetooth, or short-range wireless communication.

6. A method for processing information in an information processing apparatus that includes a transmission unit configured to transmit data to the outside based on a set transmission address, the method comprising:
receiving address data for setting the transmission address from an information terminal via a communication medium;
displaying, when the received address data contains a plurality of addresses, a selection screen for prompting a user to select an address to be set as the transmission address among the plurality of addresses according to reception of the address data; and
setting, when a number of addresses contained in the address data received by the reception unit is one, the address as the transmission address without displaying the selection screen.

7. A computer-readable storage medium storing a computer-executable process that causes an information processing apparatus including a transmission unit configured to transmit data to the outside based on a set transmission address to execute a method comprising:
receiving address data for setting the transmission address from an information terminal via a communication medium;
displaying, when the received address data contains a plurality of addresses, a selection screen for prompting a user to select an address to be set as the transmission address among the plurality of addresses according to reception of the address data; and
setting, when a number of addresses contained in the address data received by the reception unit is one, the address as the transmission address without displaying the selection screen.
